(19) United States
(12) Patent Application Publication
(10) Pub. No.: US 2026/0259744 A1
(43) Pub. Date: Sep. 3, 2026

(54) Systems, Methods, and Computer Program Products for Configurable Mapping of Data Elements

(71) Applicant: XERO LIMITED, Te Aro, Wellington (NZ)

(72) Inventors: Kah Geh Tan, Te Aro, Wellington (NZ); David Lyon, Te Aro, Wellington (NZ); Jonathan Fong, Te Aro, Wellington (NZ); Louis Pienaar, Te Aro, Wellington (NZ); Joseph Fajardo, Te Aro, Wellington (NZ); Manoj Mahendra, Te Aro, Wellington (NZ)

(21) Appl. No.: 19/489,484

(22) PCT Filed: Jun. 6, 2024
(86) PCT No.: PCT/NZ2024/050064

§ 371 Date: Dec. 2, 2025

(30) Foreign Application Priority Data
Jun. 7, 2023 (AU) 2023901804

(51) Int. Cl. G06F 9/445; G06F 8/38

(52) U.S. Cl. CPC G06F 9/44505; G06F 8/38

(57) ABSTRACT

A computer-implemented method comprises: determining a data source comprising a plurality of data elements, each data element being associated with a respective data element identifier; determining a user-defined configuration file for configuring a user interface, the configuration file comprising one or more of the data element identifiers, and for each of the one or more data element identifiers, a respective field identifier corresponding to a field of the user interface; determining the one or more of the plurality of data elements from the data source associated with the respective data element identifiers; determining generic list items and associated generic data; determining user interface configuration data based on the user-defined configuration file, the data elements, the generic list items and the associated generic data; and providing the user interface configuration data to a client device for generating the user interface.

### CROSS-REFERENCE TO RELATED APPLICATION(S)

This application is a 371 national stage of International Patent Application Serial No. PCT/NZ 2024/050064, filed on Jun. 6, 2024, which claims priority to Australian Patent Application Serial No. 2023901804, filed on Jun. 7, 2023, the entire contents of which are incorporated herein by reference.

### TECHNICAL FIELD

The present disclosure relates to methods, systems and computer program products for configurable mapping of data elements. Some embodiments relate to mapping data of a first data structure onto a one or more second, different data structures.

### BACKGROUND

Data organisational structures are important for building and maintaining effective and efficient data sources. Data sources, such as databases, may have defined data structures by which the data elements stored therein are organised in an efficient, easily accessible and logically related manner. However, data elements of other data sources and/or products may have differing data structures for a variety of reasons. Accordingly, differing data structures may lead to different data sources and/or systems lacking proper or sufficient interoperability. This lack of interoperability may necessitate the development of bespoke systems tailored to function with particular data sources having particular data structures.

It is desired to address or ameliorate some of the disadvantages associated with prior methods and systems, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments are directed to a method comprising: determining a data source comprising a plurality of data elements, each data element being associated with a respective data element identifier; determining a user-defined configuration file for configuring a user interface, the configuration file comprising one or more of the data element identifiers, and for each of the one or more data element identifiers, a respective field identifier corresponding to a field of the user interface; using the one or more of the plurality of data element identifiers, determining the one or more of the plurality of data elements from the data source associated with the respective data element identifiers; determining generic list items and associated generic data; determining user interface configuration data, the user interface configuration data being based on the user-defined configuration file, the one or more of the plurality of data elements, the generic list items and the associated generic data; and providing the user interface configuration data to a client device for generating the user interface comprising one or more user-defined list items.

In some embodiments, the user-defined list items comprise one or more fields of a user interface, each field being associated with a field identifier and comprising one or more of the plurality of data elements.

In some embodiments, each generic list item comprises one or more field identifiers associated with a field of a user interface; and wherein each of one or more field identifiers of the generic list items corresponds with each of the one or more field identifiers of the user-defined configuration file.

In some embodiments, determining the user-defined list items comprises mapping each of the data elements to a respective field of the user interface based on the one or more field identifiers of the generic list items and the corresponding field identifiers of the user-defined configuration file.

In some embodiments, the generic data is indicative of qualities of the fields of a user interface.

In some embodiments, the qualities of the fields of a user interface comprise: a field type; a field title; a field label; a field style; a field format; a field data type; a field data source; and one or more field logic.

In some embodiments, each of the one or more data element identifiers has an associated set of user-defined presentation information for presenting the data element on the user interface.

In some embodiments, the user-defined configuration file further comprises user-defined presentation information for presenting the user interface.

In some embodiments, the user-defined presentation information comprise one or more of: a layout type; a list type; a set of fields to be displayed; a field type; a display element visibility; a field style; a derived calculation; composite fields built from templates; text font; text colour; duration calculation; one or more date range; and/or one or more currency amount range.

In some embodiments, the one or more data elements are indicative of an: entity name; client name; business information; entity status; additional information; error status details; workflow status; work status; tax type; duration of a period; date; possible action; filed date; payment date; and/or due date.

In some embodiments, the user interface configuration data comprises filter configuration instructions.

In some embodiments, the filter configuration instructions are configured to enable a user of the client device to configure the user-defined list items.

In some embodiments, determining the user interface configuration data further comprises: determining a schema of a user-defined configuration file; determining the one or more field identifiers; determining one or more field attributes of the fields of the user interface, based on the schema and the one or more field identifiers.

In some embodiments, the schema is indicative of the logical constraints of the user-defined configuration file.

In some embodiments, determining the user interface comprises: determining a supplementary data source; and determining from the supplementary data source, based on the previously determined data source and/or the plurality of data elements, one or more supplementary data elements.

In some embodiments, the supplementary data elements of the supplementary data source are indicative of shared information that is available to all users.

In some embodiments, the supplementary data elements comprise data indicative of one or more of: an entity name; an entity location; associated entities; a responsible entity; and/or one or more logic functions.

In some embodiments, the user-defined configuration file further comprises function instructions, wherein the function instructions are indicative of operations that can be performed on one or more of the plurality of data elements.

In some embodiments, the user interface configuration data is: an API payload, or a file.

Some embodiments are directed to a non-transitory machine-readable medium storing instructions which, when executed by one or more processors of a computer, cause the computer to perform any one of the described methods.

Some embodiments are directed to a system comprising: one or more processors; and memory comprising computer executable instructions, which when executed by the one or more processors, cause the system to perform any one of the described methods.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

The embodiments of the disclosure will now be described with reference to the accompanying drawings, in which:

FIG. 1 is a schematic diagram of a system for configurable mapping of data elements, according to some embodiments;

FIG. 2 is a block diagram of a system for configurable mapping of data elements, according to some embodiments;

FIG. 3 is a process flow diagram of a method of configurable mapping of data elements, according to some embodiments;

FIG. 4 is a schematic diagram depicting determining user interface configuration data, according to some embodiments;

FIG. 5 illustrates an example of a graphical user interface that may be provided according to the method of FIG. 3 or FIG. 4, according to some embodiments;

FIG. 6A illustrates an upper portion of another example of graphical user interface that may be provided according to the method of FIG. 3 or FIG. 4, according to some embodiments;

FIG. 6B illustrates an lower portion of the graphical user interface of FIG. 6A, according to some embodiments;

FIG. 7 is an example of an API response comprising data retrieved from data source(s), according to some embodiments;

FIG. 8 is an example of a user-defined configuration file, according to some embodiments;

FIG. 9 is an example of a user interface configuration data, according to some embodiments; and

FIG. 10 illustrates a portion of a graphical user interface (GUI), according to some embodiments.

### DETAILED DESCRIPTION

The present disclosure relates to computer-implemented methods, systems, non-transitory machine-readable medium, and computer program products for configurable mapping of data elements. Some embodiments relate to mapping data elements of a first data structure onto a second data structure. In some embodiments, the disclosure relates to configurable mapping of data structures such that a data source, having a first data structure, is interoperable with a system, having a second data structure, regardless of the nature of the data or the data structures of either the data source or the system.

Data elements, such as those that are stored in and accessed from a data source, are stored according to a particular data structure. Data structures are used to store and organise data elements such that they can be accessed, associated and updated efficiently. While a particular data source may use a certain class of data structure, such as a static data structure, dynamic data structure, tree style data structure, or a graph style data structure, each data source may have a bespoke data structure associated with it. Further, data structures are not simply reserved for data sources; websites, applications or any other type of system that uses data may itself have a data structure by which data is retrieved, input into the system, processed, determined and subsequently output. Once again, each system may have its own data structure bespoke to its particular design.

Data structures that are specific to certain data sources and/or systems may lack the ability to easily and/or efficiently interact with each other, such as for sharing data, or updating data entries. Accordingly, whenever one system or data source needs to interact with another system or data source, a bespoke method of interacting may need to be designed. While this may be a suitable solution upon first conception, the method of interacting, especially if the interacting systems/data sources are not owned by the same development team or company, may not continue to work if even a minor change to either of the systems/data sources is made.

The described embodiments may improve communication between systems/data sources of different data structures. The improved communication between systems/data sources may allow for increased useability of many or all features of a particular system/data source by other systems/data sources. Accordingly, a particular feature that enables a particular functionality may only be designed once, and then configured such that it is easily interoperable with another system/data source, instead of being designed for every system/data source that wishes to avail of that particular feature. For example, and according to some embodiments, the present disclosure enables a central team to develop an application platform, and allows various client developers to design and implement different versions or instances of app/web pages that suit their particular needs, without having to design a bespoke app/web page. In one particular example, this may include regionally specific versions.

The described embodiments may improve maintainability of systems/data sources. This improved maintainability may be achieved by reducing the need to maintain disparate systems. These disparate systems may be systems that all achieve the same result but for systems/data sources with different data structures, or be bespoke systems that are configured to operate in conjunction with a system/data source to achieve a goal or deliver a functionality of service. The described embodiments may enable a change to be made on one side of a relationship between two systems/data sources without that change impacting the complimentary system/data source. For example, and according to some embodiments, the present disclosure enables changes to be made to a central application/web site without causing various data links between data sources and the application/web site being broken. In another example, a change may be applied once to a central application/web site and have that change be reflected to regional versions of that application/web site. According to some embodiments, the present disclosure may allow for all efforts towards bug fixing or otherwise system maintenance to be performed on the central system, without having to perform the same actions for each regional version of the application/web site. Further, the present disclosure may enable centralised hosting of infrastructure and deployment pipelines, thereby reducing the costs of time and resources.

A further advantage afforded by the described embodiments may be improved scalability of systems/data sources. This improved scalability may be afforded by providing a configuration layer between a first system/data source and a second system/data source. The configuration layer may enable the integration of new data sources, functionalities and/or products into an existing system/product by enabling the configuration layer to interface or interpret between the existing system/data source or ecosystem and the new data sources, functionalities and/or products.

For example, the configuration layer may form part of a digital services platform configured to generate and display user interfaces for users to engage with a particular service and/or functionality associated with the digital services platform. The configuration layer may be configured to retrieve or receive data from one or more data sources and determine instructions or otherwise cause user interfaces comprising the data to be displayed to the users via a computing device associated with each user. The digital services platform may wish to expand their product/service by incorporating the functionality of an existing digital product that is available for purchase or licensing from another provider. Using the configuration layer, any data sources associated with the existing digital product may be exposed to the configuration layer and the data therein may be incorporated into the user interface of the digital services platform by determining a configuration file, configured to adapt the existing digital product, with the digital services platform associated with the configuration layer.

The described embodiments may provide improved flexibility of systems/data sources. Improved flexibility may be achieved by allowing for particular systems/data sources to be configured for specific uses based on system/data source attributes and/or requirements. Flexibility may be enabled by the provision of the configuration layer, which enables the tailoring of data and data structures to a particular system/data source. For example, and according to some embodiments, the exigencies of particular data source(s) such as having data elements that are not present in many other data sources, or requirements that are regionally specific, such as dates that are mandated by regional bodies, for example an end of financial year date, may be accommodated quickly and easily into a central application/web site.

Another advantage which may be provided by the described embodiments is improved extensibility of systems/data sources. This may be achieved by allowing for systems/data sources to be built out and/or expanded depending on, or in accordance with, systems/data sources requirements and which may be independent of related data structures of systems/data sources used by the system undergoing development. Further, additional systems may be overlaid on existing systems without having to build bespoke interoperability systems. For example, this may be achieved by providing the configuration layer that sits between the different data structures. For example, and according to some embodiments, the present disclosure may enable a new regional version of an application/web site to be deployed easily and quickly by simply exposing a new data source to the system, and coding, generating, arranging or otherwise producing a configuration file mapping the data elements of the new data source onto the user interface of the application/web site. This may remove a need for a bespoke regional version of the application/web page to be developed.

The described embodiments may be adapted to enable improved modernisation of systems, such that improvements and/or changes, for example to increase security of a core system/data source, may be made, and subsequently made use of, by one or more disparate systems. The changes may be made to the core system/data source without either breaking the connection between the other systems/data sources or requiring those other systems/data sources to be themselves updated. For example, and according to some embodiments, a central application/website may be developed to include new functionality, security patches, performance improvements, package upgrades (dependency management) which may then be used by regional developers for their regional versions of the application/web site, without having to update or further develop the regional application/web site versions.

Yet another benefit which may be provided by the described embodiments is improved configuration/configurability for clients. This may be achieved by facilitating client configuration of a user interface such that existing systems/data sources may be customised for their specific needs, thereby improving the systems/data sources to provide particular functionalities and/or particular information to the client in an efficient manner. For example, and according to some embodiments, the present disclosure may enable a regional developer to customise their regional application/web page's client configuration capabilities to suit their particular data elements/data source, without having to develop a bespoke configuration UI/system.

The present disclosure is directed to systems and methods that enable users to quickly and efficiently customise, configure, generate and/or provide user interfaces that are data structure agnostic. In other words, the present systems and methods enable any data source to be integrated into a user interface, quickly, without the user who owns the data source having knowledge of the user interface and/or the user interface's data structure. This may allow for generation, building, providing or otherwise deploying, for example, of different versions, such as regional versions, of web pages, quickly and easily, without the need for a bespoke webpage to be developed for each instance. Further, embodiments of the present disclosure may ensure that changes to the overlying user interface will not break the links between the fields of the user interface that are populated with data and the data source that is used to populate them if either the user interface is changed or the data source is changed. The present systems and methods work to decouple data sources from a user interface, such that the two may exist independently but still be interoperable.

The embodiments of the present disclosure may enable quick and efficient collation of disparate data sources into a single web page, without the need for developing bespoke web pages to handle different data structures that may be associated with the different data sources that are being combined.

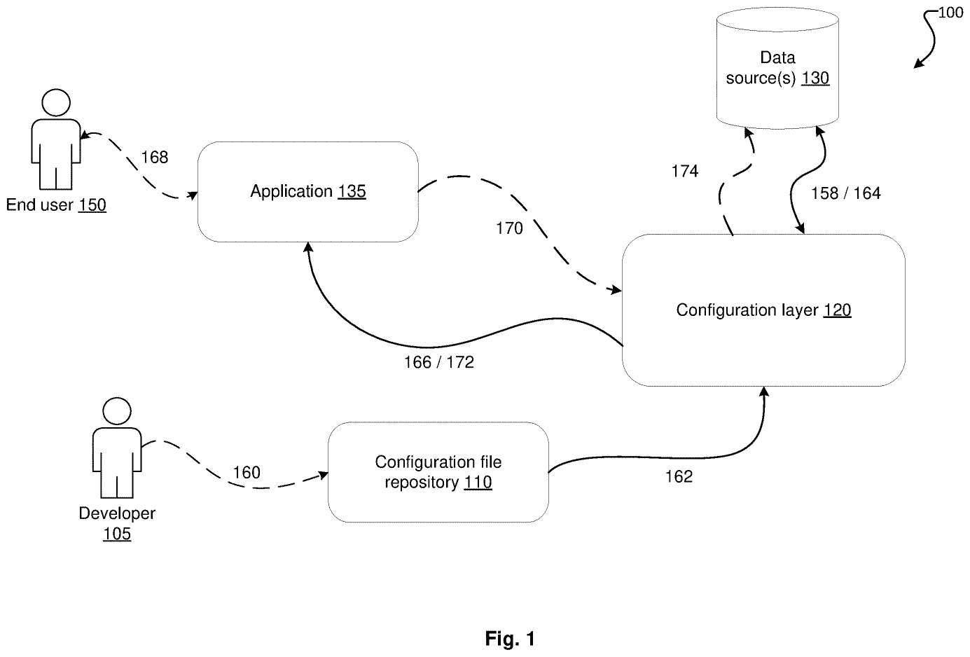

FIG. 1 is a schematic diagram that depicts a broad overview of a system 100 for configurable mapping of data elements, according to some embodiments. The system 100 may be configured to enable or facilitate the configurable mapping of data elements from a first data structure to a second, different data structure. In some embodiments, the system 100 is configured to enable a designer 105 to map or associate data elements from a data source to generic list items and/or a generic structured data list such that the structured data list may be built, generated or provided in a graphical user interface (GUI). The GUI may have a particular data structure and style that is not necessarily associated with the data structure of the data source.

The designer 105 generates, or otherwise determines, one or more user-defined configuration files for configuring, customising, building or generating a user interface to an application 135. The designer 105 may be a programmer, for example, developing one or more digital services for a digital services platform. The designer 105 may generate the user-defined configuration files using a computing device (not shown) such as a laptop or desktop computer running one or more code developing applications (not shown). The designer 105 may be a member of a client team developing a specific implementation of a web page/application, a web designer, a user interface designer, or any other type of designer who may develop web pages/applications/user interfaces for use by one or more users.

The system 100 comprises a configuration file repository 110 which includes a collection or plurality of different configuration files, such as user-defined configuration files and/or default configuration files. The configuration file repository 110 may be a database such as a code repository or memory storage on a computing device, such as a database server or any other type of computing device capable of storing the configuration files.

The system 100 further comprises a configuration layer 120 configured to receive a request, such as from the application 135, interpret the request, perform the action and respond, such as retrieving and communicating particular data from a data source 130 of the system 100 to the application 135. The configuration layer 120 may be configured to communicate with the other components of the system 100 via API, webhook, GraphQL, gRPC, and/or websocket. The configuration layer 120 may be a conglomerate of different systems and/or computing devices which, when working in concert or cooperating with one another, provide a particular functionality or host a digital services platform.

In some embodiments, the configuration layer 120 may comprise a backend service (not shown) and/or one or more cloud storage devices (not shown). The backend service may be configured to facilitate communications between the application 135, and the data source(s) 130 and the configuration file repository 110. The cloud storage may be configured to store, among other things, the configuration files. The cloud storage may be a computing device, such as a laptop, or a desktop computer, or a computing device configured to act as a server, and may, in some embodiments, comprise multiple computing devices working in cooperation.

The data source(s) 130 may be configured to store data associated with the system 100. The data source(s) 130 may be one or more databases. The data source(s) 130 may be one or more API(s). The data source(s) 130 may be one or more caches, configured to temporarily store data that may have been retrieved or received from one or more databases and/or API(s). The data source(s) 130 may be memory data. The data source(s) 130 may be one or more data stores. The data source(s) 130 may be event-based data store. The data source(s) 130 may comprise one or more data elements, the data elements accessible by configuration layer 120 for communication to the application 135.

The application 135 may be a mobile application, computer software, or a web application running on a web browser. The application 135 may be single page application as part of a website or web application that dynamically changes/updates based upon new instructions and/or data received from configuration layer 120, such as data elements or configuration files. Accordingly, the application 135 need not, or is not required to, reload an entirely new instance of a webpage when an element of the web page is updated. The application 135 may comprise one or more micro frontends and/or one or more structured data lists.

To configure mapping of data elements by the system 100, at 158, the configuration layer 120 determines the data source(s) 130. In some embodiments, determining the data source(s) 130 may be part of a system initialisation process. Determining the data source(s) 130, in some embodiments, may be caused by receipt of a request to serve an application 135 to the end user 150.

Optionally at 160, the designer 105 may generate, produce or otherwise determine a user-defined configuration file and communicate the user-defined configuration file to the configuration file repository 110. The user-defined configuration file may comprise one or more instructions for customising, configuring, building, or generating a GUI, building a GUI, dynamically building a GUI, configuring a GUI, and/or customising a GUI.

At 162, one or more user-defined configuration files and one or more default configuration files are communicated to the configuration layer 120 and caused to be stored. The one or more default configuration files may comprise a set of instructions associated with providing, configuring or customising a GUI according to the data structure associated with the application 135.

At 164, the configuration layer 120 may interpret the instructions of the configuration files. Simultaneously, or subsequently to interpreting the instructions of the configuration files, the configuration layer 120 may retrieve one or more data elements from data source(s) 130.

At 166, the configuration layer 120 may determine, based on the configuration files and the data element(s) retrieved from the data source(s) 130, a graphical user interface comprising one or more list items. The list items may comprise the data elements. Configuration layer 120, will cause user interface configuration data to be communicated to the application 135, for example, via an API payload, or a file, such as an interpretable file, where it may subsequently cause the user interface to be customised, configured or presented to end user 150.

Optionally at 168, the end user 150 may interact with the application 135, for example, by clicking, tapping or otherwise selecting an interactive on screen element and/or entering, and/or updating one or more data fields. In some embodiments, the client interaction may be indicative of a change to the user interface that the end user 150 wishes to enact.

Optionally at 170, subsequent to the end user 150 interacting with the application 135, the application 135 may communicate an indication of the client interaction to the configuration layer 120. For example, an indication of the client interaction may be an update to a data element as presented by the application 135, such as changing a value of a data field. Subsequently, at 174, the update to the data field may be communicated to the data source(s) 130 to update the data entry as stored therein. In some embodiments, the end user 150 may interact with the application 135 to define and save a custom view. The custom view may be a specific configuration of the user interface that the end user 150 may want to save for later use. Upon saving the custom view, the user interface may be presented in the future based at least partially on the saved custom view.

Optionally, at 172, the configuration layer 120 sends a user interface reconfiguration file to the application 135 for reconfiguring the user interface. For example, designer 105 may issue an update to the user interface by generating a new or altered configuration file. The update may then be pushed to the application 135 to update the user interface based on the altered configuration file.

As an example, a developer of an accounting and tax platform may wish to deploy a structured data list for displaying tax obligations for a particular region, for example the UK.

The accounting and tax platform may comprise an application, such as a mobile phone application, computer application and/or web based application, in communication with a backend for providing, generating or building a user interface and retrieving data from data sources. In some embodiments, the developer may expose and/or make available a data source comprising data relating to tax obligations of a plurality of entities, such as businesses that are active in the UK and therefore are required to pay UK tax.

To customise, configure, build or generate the structured data list comprising the UK tax obligations the developer may code, produce, generate or otherwise define a configuration file, such as a . JSON configuration file, comprising instructions for retrieving data elements indicative of the tax obligations from the exposed data source. The configuration file may be associated with a schema for interpreting the contents of the . JSON file, instructions for a configuration UI as part of the structured data list and/or instructions for qualities and/or attributes of the data elements and/or presentation information for how the data elements are to be incorporated into the structured data list. The configuration file may comprise a set of data element identifiers. Each data element identifier may be associated with a respective field or fields of the exposed data source.

The developer may submit the configuration file to the backend of the accounting and tax platform for the platform to customise, configure, build or generate the structured data list as part of the platform's application. Upon receiving the configuration file, the backend may retrieve, via an API call to the exposed data source comprising the tax obligations, a series of data entries associated with one or more tax paying entities. Each of the series of data entries may comprise a set of data elements associated with data element identifiers as defined by the configuration file.

The backend of the accounting and tax platform may determine or generate an API payload to be sent to the application running on the client's computing device. The API payload contains instructions for customising, configuring, building or generating a user interface that comprises a structured data list for presenting the data elements retrieved from the exposed data source. According to some embodiments, the API payload comprises one or more items that contain the data element identifiers and data elements received from the exposed data source. The data element identifiers and/or the data elements of the items may be retrieved based on the data element identifiers contained in the . JSON configuration file. The API payload, in some embodiments, comprises the contents of the . JSON configuration file for how the contents of the items are to be interpreted and/or presented as part of the structured data list. In some embodiments, the contents of the . JSON configuration file comprises one or more templates for generating or otherwise determining new data elements based on existing data elements. In some embodiments, the API payload comprises the instructions for a configuration UI.

The API payload, once sent to the client's computing device, may cause the application to generate and display one or more list items that comprise one or more of the data elements of the items, based on the contents of the API payload. In particular, the contents of the . JSON configuration file, now incorporated into the API payload, may be interpreted by the application so that the application knows which data elements are to be used to populate one or more fields of the user interface. Populating the one or more fields of the user interface may comprise providing the data element to the field or determining a new data element, based on one or more templates and one or more data elements.

In this way, a regionally specific user interface comprising a structured data list containing the UK tax obligations of an entity may be generated and displayed according to the rules of the application. In other words, the data of the exposed data source, having a particular data structure, is mapped onto the existing UI data structure of the application of the accounting and tax platform. This may be similarly done by another, different developer, developing for a different region, by exposing a data source and generating a . JSON configuration file to be interpreted by the back end of the platform, such that the data may similarly be mapped onto to the fields of the user interface.

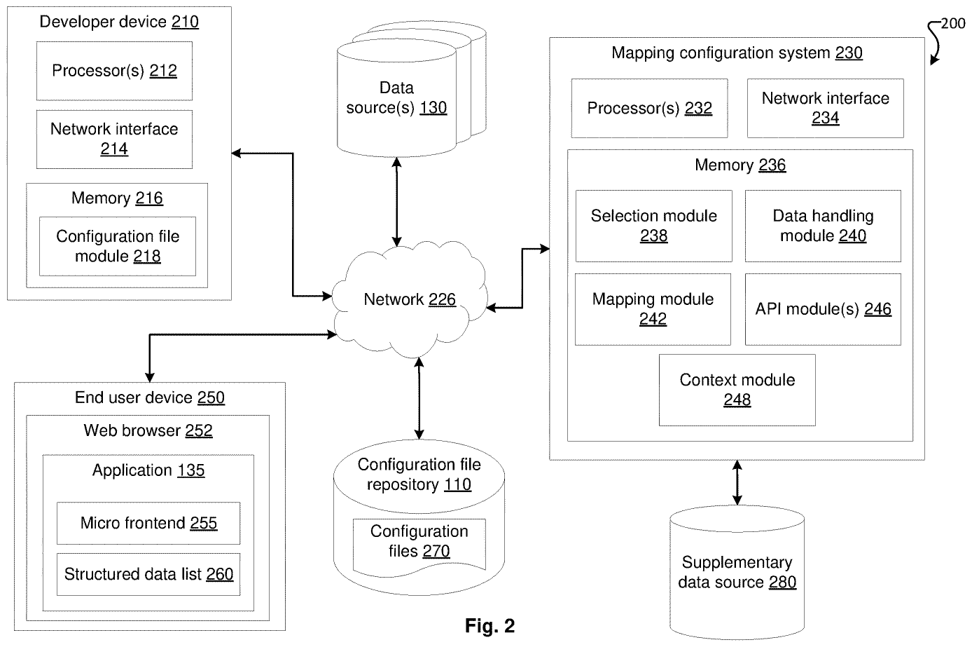

FIG. 2 is a block diagram of a system 200 for configurable mapping of data elements, according to some embodiments. The system 200 may be configured to perform the functionality of system 100 described above and/or the method 300 of configurable mapping of data elements, described in greater detail below. The system 200 may comprise developer device 210 (otherwise referred to as a client device), data source(s) 130, mapping configuration system 230, end user device 250 and/or configuration file repository 110.

The developer device 210 may comprise a mobile or handheld computing device such as a smartphone or tablet, a laptop computer, or a desktop computer, and may, in some embodiments, comprise multiple computing devices. The developer device 210 may comprise an operating system (OS) application (not shown), that enables the developer device 210 to execute one or more pieces of application software (not shown), which may be a mobile operating system if developer device 210 is a mobile device, a desktop operating system if developer device 210 is a desktop device, or an alternative operating system. The application software enables the developer device 210 and/or a developer using the developer device 210 to avail of the functionalities of the system 200. The developer device 210 may be part of a development environment (not shown). The development environment may be a collection of configured clusters, servers, databases, and/or other computing devices that collaborate to provide an environment that allows software developers and coders to generate and develop code.

The processor(s) 212 may comprise one or more microprocessors, central processing units (CPUs), application specific instruction set processors (ASIPs), application specific integrated circuits (ASICs) or other processors capable of reading and executing instruction code.

The network interface 214 facilitates communications between the components of system 200, such as the developer device 210, the data source(s) 130, the mapping configuration system 230, the end user device 250 and/or the configuration file repository 110. The network interface 214 may comprise a combination of network interface hardware and network interface software suitable for establishing, maintaining and facilitating communication over a relevant communication channel.

The memory 216 may comprise one or more volatile or non-volatile memory types. For example, the memory 216 may comprise one or more of random access memory (RAM), read-only memory (ROM), electrically erasable programmable read-only memory (EEPROM) or flash memory. The memory 216 is configured to store program code accessible by the processor(s) 212. The program code comprises executable program code modules. In other words, the memory 256 is configured to store executable code modules configured to be executable by the processor(s) 212. The executable code modules, when executed by the processor(s) 212 cause the developer device 210 to perform certain functionality, as described in more detail below. For example, the memory 216 may comprise configuration file module 218. A code module may be a collection of computer executable or computer intelligible code, that when executed by a processor, causes the processor to perform processes, actions or functionalities, such as the processes, actions or functionalities described below.

The configuration file module 218 may be an application, such as an application for developing code, with which a user may generate or otherwise determine a configuration file for use in providing, customising, configuring, building or generating a user interface. The configuration file module 218 may, in some embodiments, store one or more configuration files 270 that have previously been determined. The configuration file module 218 may be configured to communicate one or more configuration files 270 to one or more other components of the system 100, such as mapping configuration system 230 and/or configuration file repository 110.

The network 226 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 226 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The data source(s) 130 may form part of or be local to the system 200, or may be remote from and accessible to the system 200, for example, via the network 226. The data source(s) 130 may be configured to store data associated with the system 200. The data source(s) 130 may be one or more centralised databases. The data source(s) 130 may be a mutable data structure. The data source(s) 130 may be a shared data structure. The data source(s) 130 may be a data structure supported by database systems such as one or more of PostgreSQL, MongoDB, and/or ElasticSearch. The data source(s) 130 may be configured to store a current state of information or current values associated with various attributes (e.g., “current knowledge”). Each individual data source 130 may have a different data structure than that of another individual data source 130. Each individual data source 130 may store different data that another individual data source 130.

The mapping configuration system 230 is configured to receive one or more configuration files 270, and access/retrieve one or more data elements from data source(s) 130 to determine user interface configuration data for providing, customising, configuring, building or generating a user interface. The mapping configuration system 230 may comprises a processor(s) 232, a network interface 234 and memory 236.

The processor(s) 232 may comprise one or more microprocessors, central processing units (CPUs), application specific instruction set processors (ASIPs), application specific integrated circuits (ASICs) or other processors capable of reading and executing instruction code.

The network interface 234 facilitates communications between the components of system 200, such as the developer device 210, the data source(s) 130, the mapping configuration system 230, the configuration file repository 110 and/or the end user device 250. The network interface 234 may comprise a combination of network interface hardware and network interface software suitable for establishing, maintaining and facilitating communication over a relevant communication channel.

The memory 236 may comprise one or more volatile or non-volatile memory types. For example, the memory 236 may comprise one or more of random access memory (RAM), read-only memory (ROM), electrically erasable programmable read-only memory (EEPROM) or flash memory. The memory 236 is configured to store program code accessible by the processor(s) 232. The program code comprises executable program code modules. In other words, the memory 236 is configured to store executable code modules configured to be executable by the processor(s) 232. The executable code modules, when executed by the processor(s) 232 cause the mapping configuration system 230 to perform certain functionality, as described in more detail below. For example, the memory 236 may comprise the selection module 238, the data handling module 240, the mapping module 242, the API module(s) 246 and/or context module 248. A code module may be a collection of computer executable or computer intelligible code, that when executed by a processor, causes the processor to perform processes, actions or functionalities, such as the processes, actions or functionalities described below.

The selection module 238 is configured to select one or more configuration files 270 for use in providing, customising, configuring, building or generating a user interface. The selection module 238 may retrieve one or more user-defined configuration files and/or one or more generic configuration files from the configuration file repository 110 and/or the developer device 210, for example. The configuration files 270 may be stored in configuration file repository 110. In some embodiments, the selection module 238 is configured to process the configuration files 270. The selection module 238 may interpret the contents of the configuration files 270 and generate configuration data, used to determine the user interface configuration files 270. The configuration data may comprise user-defined configuration data and default configuration data.

The data handling module 240 is configured to retrieve data elements from data source(s) 130. In some embodiments, the data handling module 240 may determine one or more data elements from the configuration files 270 for retrieval from the data source(s) 130. In some embodiments, data handling module 240 may retrieve data elements based on a request to generate an application 135 or structured data list 260.

The mapping module 242 is configured to process the default configuration files to determine one or more generic list items, each generic list item comprising generic data. The mapping module 242 is configured to process the generic list items using the user-defined configuration files to determine user interface configuration data adapted to provide a user interface. The user interface may comprise a structured data list 260. The generic list items may be configurable based on the configuration files 270 and the data elements retrieved from the data source(s) 130. The mapping module 242 may comprise metadata relating to the data elements, the configuration files 270 and/or generic list items.

The API module(s) 246 are configured to communicate with the application 135 via network 226. The API module(s) 246 may be configured to send the user interface configuration data to end user device 250, such that the single page application 135 may customise, configure, build or generate the structured data list 260. The API module(s) 246 may be configured to use API protocols or architectures such as REST, RPC and/or SOAP.

The context module 248 is configured to retrieve one or more supplementary data elements associated with the data source(s) 130, the data elements of the data source(s) 130, the configuration files 270, the application 135, and/or a digital services platform (not shown) associated with the system 200. The context module 248 may retrieve the supplementary data elements from a supplementary data source 280. The context module 248 may be configured to provide the one or more supplementary data elements for use in determining the user interface configuration data. The supplementary data elements may comprise one or more of: an entity name, an entity location, associated entities, a responsible entity, and/or one or more logic functions.

The end user device 250 may be a computing device such as a personal computer, laptop computer, desktop computer, tablet, or smart phone, for example. The end user device 250 comprises a processor (not shown) and a memory (not shown). The processor being configured to read and execute program code and the memory being configured to store program code accessible by the processor. The end user device 250 may comprise a web browser 252, configured to communicate with web servers to serve web pages to the end user 150.

The web browser 252 is configured to enable the end user 150 to access websites. When the end user 150 requests a web page, such as a web page comprising the application 135, from a particular website, the web browser 252 retrieves its files from a web server and then displays the page on a display screen (not shown) of the end user device 250. The web browser 252 may be one or more of Google Chrome, Safari browser, Firefox browser, and/or Microsoft Edge browser. The end user 150 may download the web browser 252 via another web browser (not shown) or, if the end user device 250 is a mobile device, the end user 150 may download the web browser 252 via an app store, such as the Apple App Store or the Google Play store.

The end user device 250 may include additional applications that are not illustrated in FIG. 2, such as an operating system application, which may be a mobile operating system if end user device 250 is a mobile device, a desktop operating system if end user device 250 is a desktop device, or an alternative operating system.

A micro frontend 255 is a “microapp” which may be included in the application 135. Each micro frontend 255 instance may be configured to operate independently and/or in conjunction with any other element of the application 135. Each application 135 may comprise one or more micro frontend 255. The micro frontend 255 may operate independently or semi-independently from the application 135, in that a micro frontend 255 instance may be caused to be initially executed by the application 135, but update and function independently thereafter.

The structured data list 260 comprises one or more list items. Each list item comprises one or more fields. The structured data list 260 may be determined based on a generic list item that is configured based on the configuration files 270. In some embodiments, the generic list item may comprise or be governed by a data structure, one or more visual styles and/or semantic types, such that the data structure, visual styles and/or semantic types control the functionality and/or appearance and/or structure of the generic list item. Accordingly, the one or more list items of the lists may comprise components and/or attributes based on the configuration files 270, and data elements retrieved from data source(s) 130, which are arranged and/or controlled by the data structure of the generic list item. In some embodiments, the structured data list 260 may be a micro frontend 255.

The configuration file repository 110 may comprise configuration files 270. The configuration files 270 may comprise user-defined configuration files, and/or default configuration files, such as received from developer device 210. Each user-defined configuration file and/or default configuration file may be associated with a different application 135 and/or a different structured data list 260.

The user-defined configuration files comprise instructions which, when executed by one or more of the components of the system 200, enable customisation, configuration, building or generation of a user interface, customised according to the particular configuration instructions contained within the user-defined configuration files. The default configuration files comprise default instructions for building or generating a default user interface. The default configuration files may comprise instructions associated with all or most elements that the default user interface may comprise or is otherwise capable of comprising. In some embodiments, the configuration file repository 110 may comprise more than one default configuration file, such as if the system 200 services more than one type of application 135.

The supplementary data source 280 may be one or more data sources, such as one or more databases that comprise one or more supplementary data elements. The supplementary data source 280 may be one or more databases associated with the system 200. In some embodiments, the mapping of the supplementary data may be done via a database schema. The supplementary data may, according to some embodiments, be mapped using keys. The one or more data source(s) 130 may comprise one or more data keys that associate the contents of the data source(s) 130 with the contents of the supplementary data source 280. The supplementary data source 280 may comprise data elements indicative of an entity name, an entity location, associated entities, a responsible entity, and/or one or more logic functions. The supplementary data source 280 and its contents may be accessible to all users of the system. In this way, the supplementary data elements may constitute generalised data, or otherwise data that is globally applicable to some, most or all other data, such as data from data source(s) 130, that the system 200 handles.

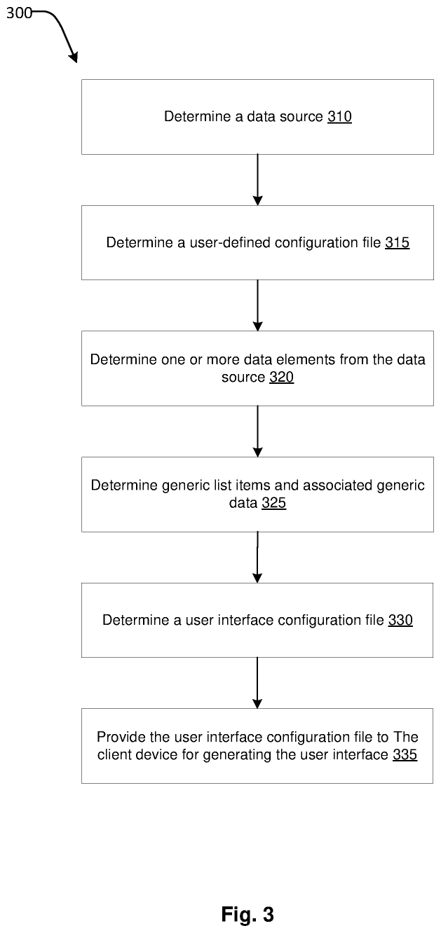

FIG. 3 is a process flow diagram of a method 300 of configurable mapping of data elements. The method 300 may be performed by the system 100 or the system 200, as described above.

At 310, the mapping configuration system 230 determines one or more data sources 130. In some embodiments, determination of the data source 310 may be performed by the processor(s) 232 executing the data handling module 242. At 310, the mapping configuration system 230 may be caused to determine the data source(s) 130. For example, the mapping configuration system 230 may be caused to determine the data source(s) 130 in response to a request from end user device 250 to serve a particular web page of a website associated with the system 200. In some embodiments, the mapping configuration system 230 may be caused to determine the data source(s) 130 as part of a system set-up or system start-up procedure. The data source(s) 130 may be determined by the mapping configuration system 230 when the data source(s) 130 are brought online, and/or are connected to system 200. In some embodiments, the mapping configuration system 230 may determine whether, for example, confirm that communication between the mapping configuration system 230 and the data source(s) 130 has been established. In some embodiments, the mapping configuration system 230 may determine whether, and for example, confirm that, the mapping configuration system 230 and/or the data source(s) 130 comply with the security system(s). Determining the data source(s) 130 may comprise determining one or more data source attributes. Data source attributes may comprise a data source geo-location, an owner of the data source, and/or a data source language. According to some embodiments, 310 may correspond to 164 of FIG. 1.

The data source(s) 130 comprise a plurality of data elements. The data elements of the data source(s) 130 may be arranged according to a data structure. The data elements may comprise data relating to entity names, entity locations, dates, action item statuses, associated entities, account balances, entity geo-locations, workflow status, possible action, payment date, and/or any other information that relates to entities and/or actions of an entity. For example, an entity may be a person and/or a business/company.

Each of the data elements may be associated with a respective data element identifier. The data element identifier may be used to associate and/or locate data elements with the respective data source(s) 130. The data element identifier may be a text string, which when interpreted by a computing device, causes the associated data element to be located within and/or retrieved from the data source(s) 130. In some embodiments, the data elements of the data source(s) 130 may be associated with the supplementary data elements of the supplementary data source 280, such as by a data key.

At 315, the mapping configuration system 230 determines a user-defined configuration file. In some embodiments, determining the user-defined configuration file 315 may be performed by the processor(s) 232 executing the selection module 238. The user-defined configuration file may be generated, or created by the user and provided to, or saved to, and/or communicated to the configuration file repository 110. Determining the user-defined configuration file may comprise retrieving and/or receiving the user-defined configuration file from the configuration file repository 110.

The user-defined configuration file may comprise one or more of the data element identifiers. In some embodiments, each of the data element identifiers of the user-defined configuration file may have or be associated with a respective field identifier. The field identifier may be associated with or otherwise correspond to a field of a user interface. According to some embodiments, the user-defined configuration file may comprise, for one or more of the data element identifiers, a set of user-defined presentation information for presenting the data element on the user interface. The user-defined presentation information may comprise instructions for a field to be shown or not shown, a field label, a field style, a field data source indicator, composite fields, presentation logic, navigational elements such as tabs, a list type, field type, display element visibility, text font, text colour, duration calculation, one or more date range, one or more currency amount range, and/or any other instructions associated with the user interface. In some embodiments, the user-defined presentation information may comprise field logic that is directed to how a data element of the field is to be calculated, determined, derived, generated and/or retrieved. In some embodiments, the user-defined presentation information may be directed to global instructions for presenting the entire structured data list, application and/or user interface generally, rather than defining per-field instructions. However, it will be appreciated that in some instances the set of user-defined presentation information may be a null set, in which case, a default set of presentation instructions may be applied, for example.

In some embodiments, the user-defined configuration file may comprise a schema. The schema may be indicative of the logical constraints of the user-defined configuration file. In other words, the schema may be indicative of the data structure of the generic list items and/or the generic data of the generic list items, described in greater detail below. The schema may act as a source of knowledge of the user-defined configuration file, in that the contents of the user-defined configuration file may be interpreted based on the instructions or rules defined by the schema. In some embodiments, the schema may also be configured to inform the user of the logical constraints of the user-defined configuration file, such as suggesting field identifiers, functions, and/or values that may be used as part of the user-defined configuration file.

In some embodiments, the user-defined configuration file may comprise filter configuration instructions. The filter configuration instructions may be configured to define a filter capability of the structured data list 260. For example, the filter capability may allow a user to configure the structured data list 260 in a particular way. The filter configuration instructions may comprise filter data bindings and/or filter UI configuration instructions. The filter data bindings may be indicative of the relationship between the data elements and/or the fields of the structure data list and the filter capability. The filter UI configuration instructions may be indicative of how the filter UI is to be presented or otherwise generated in the structured data list 260 or application 135. According to some embodiments, 315 may correspond to 162 of FIG. 1.

At 320, the mapping configuration system 230 determines one or more data elements from the data source. In some embodiments, determining the data elements 320 may be performed by processor(s) 232 executing data handling module 240. The mapping configuration system 230 may process the configuration files 270 to determine the data element identifier(s) included in the user-defined configuration file. The data element identifiers may be text strings that indicate the locations of the one or more data elements in one or more of the data source(s) 130. The mapping configuration system 230 may request, from the data source(s) 130 and based on data element identifiers, the one or more data elements associated with the data element identifiers. Each of the determined data elements is associated with a respective field label of the user-defined configuration file.

In some embodiments, the mapping configuration system 230 may determine one or more supplementary data elements from the supplementary data source 280. According to some embodiments, the context module 248 may determine the supplementary data elements from the supplementary data source 280. The supplementary data elements may be caused to be determined based on the data element identifier(s) or data keys of the user-defined configuration file. In some embodiments, the supplementary data elements may be caused to be determined based on data element(s) retrieved from the data source(s) 130, such as based on a reference key of the data source(s) 130 and/or a relational database schema. According to some embodiments, 320 may correspond with 164 of FIG. 1.

At 325, the mapping configuration system 230 determines generic list items and associated generic data. In some embodiments, the generic list items may be referred to as items. In some embodiments, the generic list items may be list items that have a genericized data structure or are otherwise universally interpretable by the system 200. In other words, the generic list items may be configured to be receivable, understandable, interpretable and/or executable by some, most or all of the components of system 200. Put another way, the generic list items may be universally interpretable by the components of system 200. The generic data may, similar to the generic list items, be universally interpretable by some, most or all elements of the system 200.

In some embodiments, determining generic list items and associated generic data 325 may be performed by processor(s) 232 executing mapping module 242. In some embodiments, the mapping configuration system 230 may determine the generic list items and the generic data based on the data elements 132 retrieved from the data source(s) 130. According to some embodiments each generic list item may comprise a set of data element identifiers 412 and associated data elements 132. Each generic list item may comprise the same set of data element identifiers, and each associated data element may be specific to that generic list item. In some embodiments, each generic list item may comprise a mostly similar, mostly different or completely different set of data element identifiers, and each associated data element may be specific to that generic list item. In some embodiments, the generic data is also indicative of how the generic list items and or the generic data should be processed by the system 200.

The generic list items may be generic system items that are configurable to present, in a structured list, one or more data elements in one or more fields, as part of a user interface. The generic data of the generic list items may comprise or be a data structure, or otherwise be indicative of instructions that describe, or otherwise enable the functionality of the generic list items and/or the configurability of the generic list items. The generic list items and their associated data are configured to be interpretable by the end user device (otherwise referred to as a client device) 250 and/or the application 135, so as to be able to be incorporated into the structured data list 260. According to some embodiments, 325 may correspond with 166 of FIG. 1.

At 330, the mapping configuration system 230 determines user interface configuration data. In some embodiments, determining the user interface configuration data 330 is performed by the processor(s) 232 executing mapping module 242. The user interface configuration data is configured to cause the end user device 250 to generate or otherwise provide a user interface comprising the structured data list 260.

In some embodiments, the mapping configuration system 230 determines the user interface configuration data by determining the field identifiers that are indicative of the fields to be included in the user interface. For example, the mapping configuration system 230 may determine field identifiers “clientName”, “status”, “period”, and/or “dueDate”. In some embodiments, the mapping configuration system 230 may determine the user-defined configuration file schema (the schema). The schema may comprise a set of instructions or otherwise, that is indicative of the logical constraints of the user-defined configuration file. For example, the schema may define/identify the field identifiers and what they are indicative of, what data types may be comprised within the user-defined configuration file, functions that may be used or called within the user-defined configuration file, and/or any other variables within the user-defined configuration file.

The mapping configuration system 230, in some embodiments, may use the schema to interpret the previously determined field identifiers and/or the user-defined presentation information. In some embodiments, the mapping configuration system 230 may determine one or more templates, equations and/or functions within the user-defined configuration file. Templates, equations and/or functions may be configured to calculate or otherwise derive data elements from other data elements, such as a duration of time, an amount of money owing, a deadline, or any other data element that may be derived from the data elements determined from the data source(s) 130. In some embodiments, the functions included in the user-defined configuration file may be bespoke functions that are not included in the data source(s) 130 or the mapping configuration system 230. In this instance, the mapping configuration system 230, based on the contents of the user-defined configuration file, may determine, from another system/data source (not shown), the particular function.

In some embodiments, the user interface configuration data comprises one or more sets of field identifiers and associated data elements, retrieved or otherwise determined from the data source(s) 130 and/or the supplementary data source 280. The user interface configuration comprises, in some embodiments, the user-defined presentation instructions, as determined from the user-defined configuration file. According to some embodiments, the user interface configuration data comprises the filter data bindings and/or the filter UI configuration instructions. According to some embodiments, 325 may correspond with 166 of FIG. 1.

At 335, the mapping configuration system 230 provides the user interface configuration data to the end user device 250 for generating the user interface 335. In some embodiments, providing the user interface configuration data to the end user device 250 may be performed by the processor(s) 232 executing the API module(s) 246. The user interface configuration data may be configured to provide one or more of the application 135, the micro frontend 255 and/or the structured data list 260. In some embodiments, the application 135 may already have been provided and the micro frontend 255 and/or the structured data list 260 may be provided subsequent to the application 135. According to some embodiments, 325 may correspond with 166 of FIG. 1.

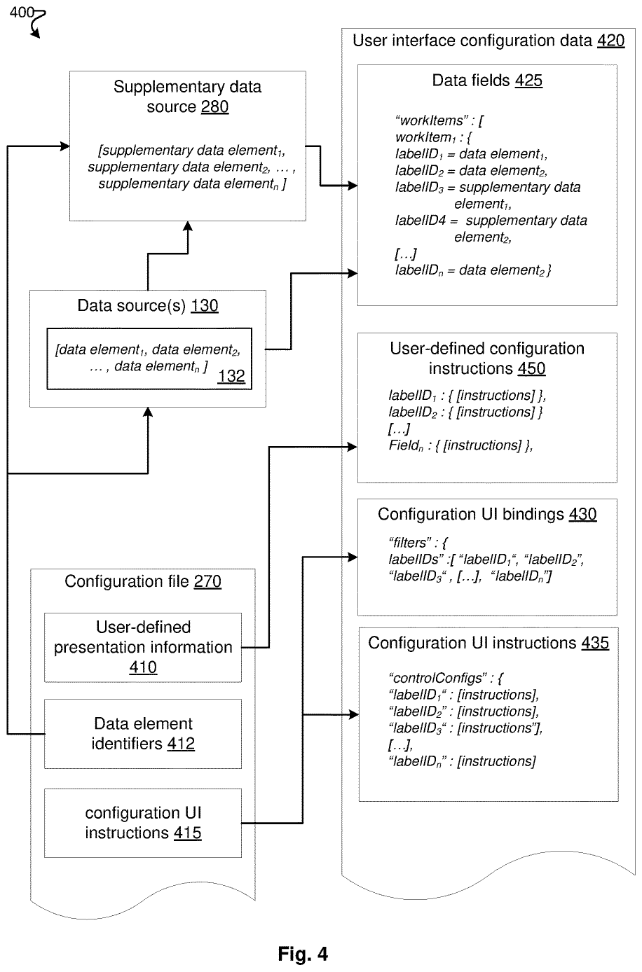

FIG. 4 is a schematic diagram of the process 400 of determining the user interface configuration data, as described above, and as specifically described at 330. The process 400 depicts the configuration file 270, the data source(s) 130, the supplementary data source 280 and user interface configuration data 420.

The configuration file comprises user-defined presentation information 410, data element identifiers 412, and/or configuration UI instructions 415. The user-defined presentation information, as described above, is determined by the mapping configuration system 230, and is incorporated into the user interface configuration data 420. The user-defined presentation information 410 may comprise one or more field identifiers and associated instructions that relate to qualities of the field of the user interface associated with respective field identifier. The instructions may comprise a visual type, such as whether the field is a title, a data field, a text field, or an image field. The instructions may comprise one or more properties, such as whether the field is to be displayed, a data type and/or a display format, such as a date display format. The instructions may comprise a data source, or otherwise referred to as the data element identifier, configured to locate the data element associated with the field identifier and accordingly the field of the user interface. The instructions may comprise a template, such as how a data element may be derived from other data elements, such as calculating a duration, a deadline, an amount remaining, and/or an amount already paid. The user-defined configuration instructions 450 may comprise a list comprising all the field identifiers included in the user interface configuration data 420. The order of the list may be indicative of the order that the fields will be presented as part of the structured data list 260. According to some embodiments, this may correspond with 330 of method 300.

The mapping configuration system 230 may use the data element identifiers 412 to determine one or more data elements and/or one or more supplementary data elements from the data source(s) 130 and/or the supplementary data source 280. The mapping configuration system 230 may determine or otherwise retrieve the one or more data elements and/or supplementary data elements and cause them to be added, appended or otherwise included in the user interface configuration data. The data elements and/or supplementary data elements may be caused to be added to the data fields 425, in some embodiments this may correspond with 320 and/or 330 of method 300.

The data fields 425 may comprise a set of one or more items. Each work item may comprise one or more data elements and/or supplementary data elements. For example, each work item of the set of items may comprise: “organisation Id”, “taxType”, “obligationType”, “periodStartDate”, “periodEndDate”, “dueDate”, “status”, “clientName”, “dueDateRelativeDateLabel”, and/or “dueDateRelativeDay”. Not all of the data elements and/or the supplementary data elements of each of the items may be included in the user interface.

The mapping configuration system 230 may determine from the configuration UI instructions 415 the configuration UI bindings 430 and/or the configuration UI instructions 435. The configuration UI bindings 430 may comprise instructions associated with filters, searching and/or sorting. The configuration UI bindings 430 may be instructions that enable or are otherwise indicative of the types of data elements and/or field identifiers that may be used to filter the structured data list 260 and/or what data may be filtered. The configuration UI bindings 430 may comprise instructions that enable or are otherwise indicative of the types of data elements and/or field identifiers that may be searched for within the structured data list 260. The configuration UI bindings 430 may comprise instructions that enable or are otherwise indicative of the types data elements and/or field identifiers that may be used to sort the structured data list 260. In some embodiments, the configuration UI binds 430 may be a list of field identifiers that may comprise, some, most or all of the field identifiers of the set of items and/or the user-defined configuration instructions 450.

The mapping configuration system 230 may determine, from the filter configuration instructions, the configuration UI instructions 435. The configuration UI instructions 435 may comprise instructions for how the configuration UI may be presented and/or what configuration options may be included in the UI. For example, the configuration UI instructions 435 may comprise instructions that cause two text entry fields to be generated as part of the configuration UI, wherein the end user 150 may enter a start date and an end date. The end user 150 may then select or otherwise interact with an onscreen confirm element, that, upon interaction causes the structured data list 260 to only display list items that are associated with the particular period between the start date and end date entered by the end user 150. The configuration UI instructions 435 may comprise any other instructions that relate to the presentation, arrangement, functionality and/or associated data elements, supplementary data elements and/or field identifiers that may be used to organise, alter, and/or transfer the structured data list 260 and/or the contents thereof.

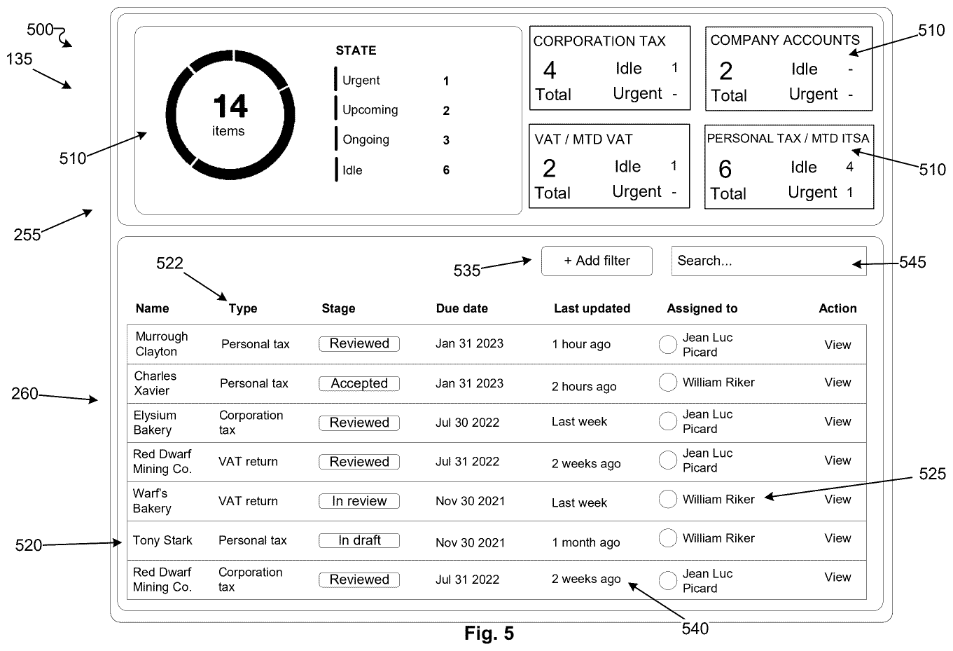

FIG. 5 is an example of a graphical user interface (GUI) 500 that may be provided according to the method 300, according to some embodiments. The GUI comprises the application 135. The application 135 comprises the micro frontend 255 and the structured data list 260. The micro frontend 255 may be configured to operate, update and display information to the end user 150 independent of the application 135 in that the application 135 may not be required to reload to allow the contents of the micro frontend 255 to update. The micro frontend 255 comprises one or more display elements 510. The display elements may display data from the data source(s) 130 and/or summary or additional data calculated, derived or otherwise determined from the data of the structured data list 260. For example, the display elements 510 as depicted in FIG. 5 indicate a breakdown of how many items are in the structured data list 260 and an indication of the total number of each list item in four different states.

The structured data list 260 comprises one or more list items 520 and column labels 522. The column labels 522 may be indicative of the type of data that is being presented in that column of the structured data list 260. The column labels 522 may be defined by the user-defined configuration file. In some embodiments, the column labels 522 may be automatically determined based on the data elements in the particular column of the structured data list 260. Each of the list items 520 comprises one or more fields 525. For example and as depicted in FIG. 5, the fields 525 may depict data relating to name, type, stage, due date, last time the list item 520 or the data comprised in the list item 520 was updated, a responsible entity, such as a person the list item 520 has been assigned to and an action. In some embodiments, the fields 525 that are indicative of the action may be interactive elements, that when interacted with by the end user 150, may cause a different user interface to be generated.

The structured data list 260 may comprise interactive onscreen configuration element 535. The interactive onscreen configuration element 535 may be configured to enable the end user 150 to alter the user interface to their preferred appearance, and/or configure the mapping of the data elements of the data source(s) 130 to the fields 525 of the structured data list 260.

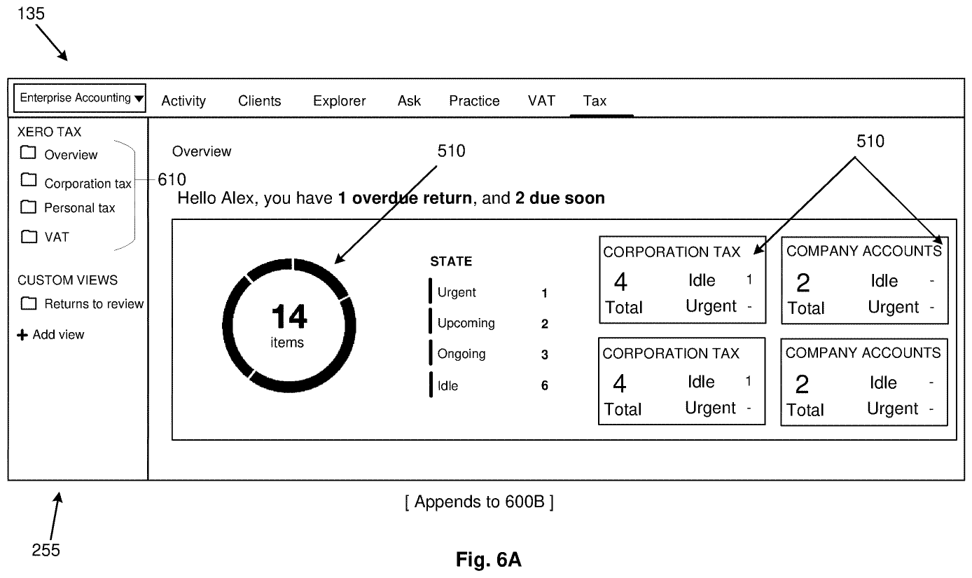

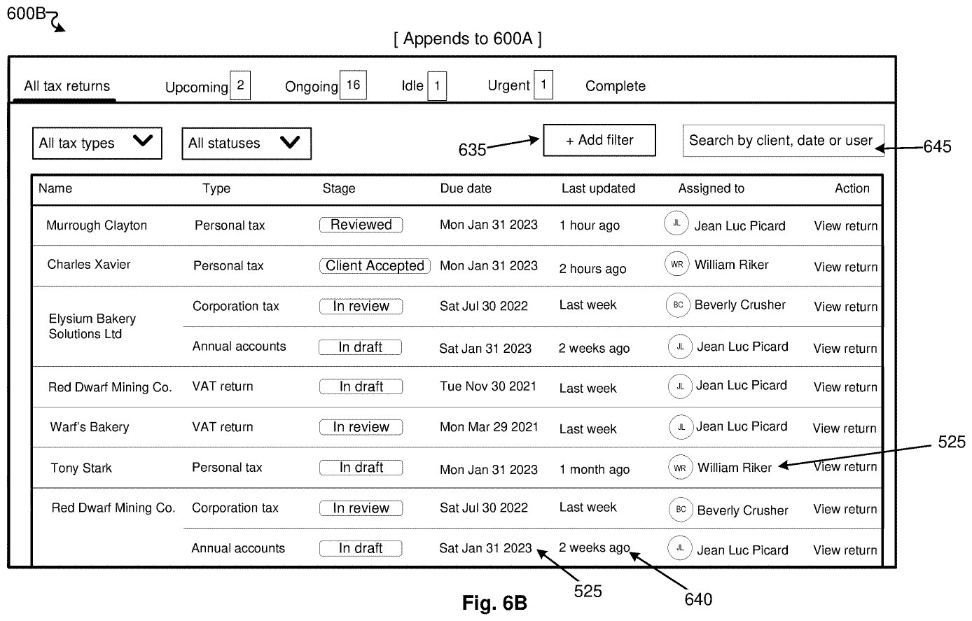

FIGS. 6A and 6B, in combination, illustrate another example of graphical user interface that may be provided according to the method of FIG. 3 or FIG. 4. FIG. 6A illustrates an upper portion 600A of the GUI, and FIG. 6B illustrates a lower portion 600B of the GUI.

Generic list items and generic data may comprise components that are shared or common across a plurality of GUIs provided by the system 200. Generic list items and generic data may represent features or components of a core capability of the system 200.

A core capability, as defined by one or more generic list items and generic data, can be reusable by designers 105 of GUIs of the system 200. A core capability can exhibit different presentations and behaviours which are determined via independently managed configurations.

A core capability of the system may comprise a GUI component that has a genericized data structure. A core capability of the system may comprise a GUI component such as a set of selectable tabs (e.g., tabs 610, or menu tabs 1005). A core capability of the system may comprise a field whose data value is determinable from the value(s) of another field or fields (e.g., a subtotal field or an amount owing field).

Different GUI (e.g. 500, 600A and 600B, and 1000), may be provided by the system 200. A core capability of the system may provide a similar look and feel of the GUIs, for users using different GUIs provided by the system 200.

The features of a core capability, as defined by generic list items and generic data, may be available to be reused by different end users 150 or designers 105 of the system 200. The features of a core capability, as defined by generic list items and generic data, may be reconfigured by different end users or developers to meet the specific needs of those end users. The different end users of the system may comprise end users from regionally disparate teams of end users.

The core capabilities, as defined by the generic list items and the generic data, may define GUI components that provide a consistent user experience across a plurality of embodiments of the GUI. The inclusion of core capabilities in each of a plurality of GUIs may reduce the cognitive load for users of the plurality of GUIs. The inclusion of core capabilities in each of a plurality of GUIs may allow for configurability of the GUIs, but within the boundaries of a consistent user interface experience. A consistent user interface experience may ameliorate the burden on users to adapt to how each GUI, and the components on those GUIs, behave or function.

The inclusion of the same core capability in different GUIs provided by the system 200 may provide homogeneous behaviour interactions and maintain the user interface experience in line with established design principles for the system 200.

Generic lists and generic data may define content blocks that use the same underlying technology and a consistent user interface design, while also catering for different requirements, such as different tax types and regions.

In an example in which each GUI in a set of related GUI are developed by different development teams, there may be an inherent risk that the look and feel of the GUIs diverge during progressive development. The inclusions of core capabilities in each of a plurality of GUIs may ameliorate the issue of divergence in the look and feel of related GUIs.

In one example, a core capability, as defined by one or more generic lists and generic data, comprises a control panel. The control panel comprises GUI components configured to provide search (e.g. 545, 645), sort, filter (e.g. 535, 635) and paginate functionalities.

The generic lists and the generic data may define a layout of the GUI. In an example, the overall page layout can be defined by the generic lists and the generic data to allow space for regional development teams' display elements 510, such as the summary widgets in both GUI 500 and upper portion 600A of GUI. The summary widgets may comprise micro-frontends, which may be developed and controlled by the regional development team.

In some embodiments, the generic data is indicative of how the generic list items and or the generic data should be processed by the system 200. For example, generic data may indicate how the generic list items, which denote the last updated date of a tax return item, should be represented within the GUI. As illustrated in FIGS. 5 and 6B at 540 and 640 respectively, the last updated date is represented as being within a pre-specified date category, such as ‘1 hour ago’, ‘Last week’, or ‘1 month ago. Representing a date as being within a pre-specified date category may enable a user to more readily determine the approximate age of the tax return item. Consistently representing dates in this manner across a plurality of GUIs provided by the system 200 may provide a consistent look and feel of the date information for users.

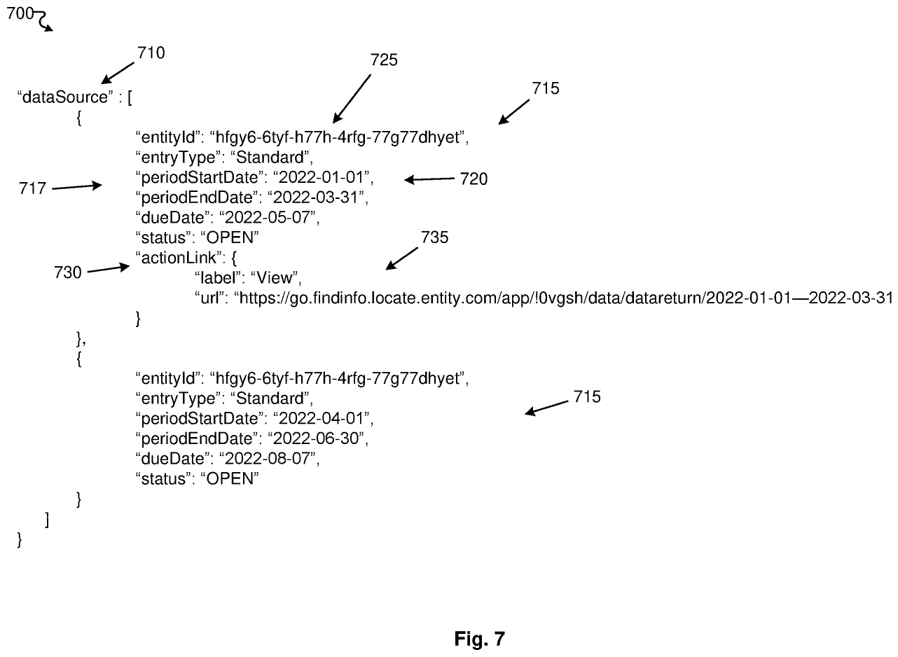

FIG. 7 is an example of an API response 700 comprising data retrieved from data source(s) 130. The configuration system 230 may receive API response 700 by querying data source(s) 130, such as via an API call. The API response 700 may comprise response identifier 710, configured to identify the data source and/or the data in the API response 700. The response identifier 710 may be used by the configuration system 230 in identifying and/or processing the received data. The API response 700 may comprise one or more data entries 715. The data entries 715 may comprise one or more data element identifiers 717 and associated data elements 720. Each data entry 715 may comprise the same, similar or different data element identifiers 717. Each of the respective data elements 720 associated with the data element identifiers 717 are specific to that particular data entry 715. The data element identifiers 717 may correspond to the data element identifiers of the user-defined configuration file. Each data entry 715 may comprise a primary identifier 725 that is used to identify related data stored in data source(s) 130. In some embodiments, all data entries 715 will be associated by the same primary identifier 725. In some embodiments, the API response 700 may comprise data entries with different primary identifiers 725, such as when the structured data list 260 is configured to collate data from different data source(s) 130, and/or from different entities. In some embodiments, the API response 700 may comprise action link identifier 730 and associated action link data elements 735. The action link identifier 730 and action link data elements 735 may be configured to generate an interactive onscreen element that enables additional functionality of the list items 520. For example, action link identifier 730 and action link data elements 735 may enable an end user 150 to interact with an onscreen element to view a document that comprises additional data related to the particular list item 520.

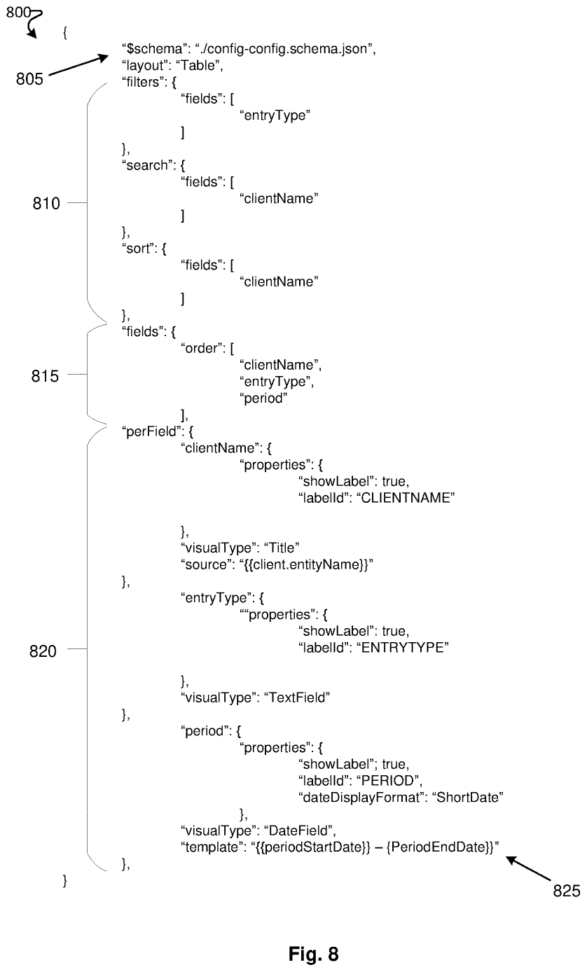

FIG. 8 is an example of a user-defined configuration file 800, according to some embodiments. The user-defined configuration file 800 may comprise schema information 805 configured to define what information can be included in the user-defined configuration file 800 and the rules for that information and what actions that information can perform and what processes the information can be used in. The user-defined configuration file 800 comprises configuration UI instructions 810 configured to enable the generation and/or provision of a configuration UI as part of the application 135. The configuration UI instructions 810 may be equivalent to configuration UI instructions 415 described above. The configuration UI instructions 810 may comprise instructions for filtering the list items 520, searching through list items 520 and/or sorting list items 520. The user-defined configuration file 800 comprises order information 815 for determining the order that the fields of the structured data list 260 are displayed. The user-defined configuration file 800 comprises identifier configurations 820 configured to define the way in which the data elements associated with each of the data element identifiers are to be handled and/or presented as part of the structured data list 260. In some embodiments, identifier configurations 820 may comprise template instructions 825. The template instructions 825 may be instructions for how a new data element may be derived or otherwise determined based on other data elements. For example, a duration of time may be calculated by determining the difference between a start date and an end date.

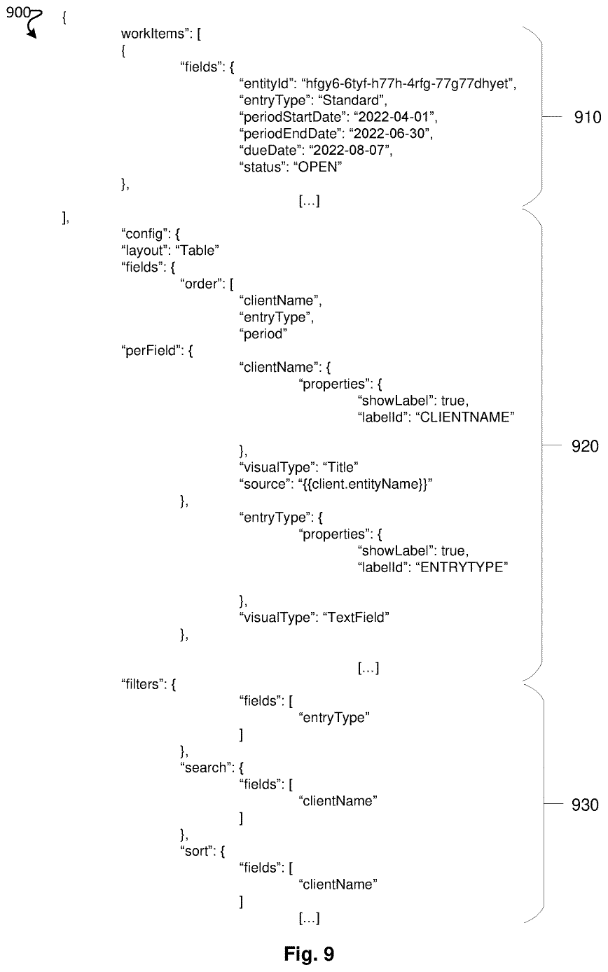

FIG. 9 is an example of a user interface configuration data 900. The user interface configuration data 900, as depicted in FIG. 9, may be an API payload. The user interface configuration data 900 comprises items 910 which correspond to the data entries of the API response 700. The data element identifiers and data elements of the items 910 are configured based on the configuration instructions 920 for inclusion into the structured data list 260. The configuration instructions 920 correspond to order information 815 and identifier configurations 820 of the user-defined configuration file 800. The configuration UI instructions 930 correspond to configuration UI instructions 415 and configuration UI instructions 810.

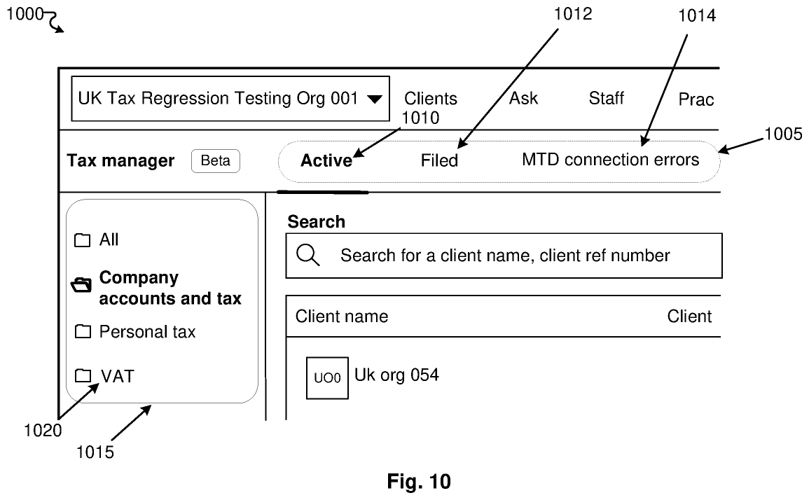

FIG. 10 illustrates a portion of a graphical user interface (GUI) 1000, in accordance with an embodiment. The GUI 1000 comprises a set of menu tabs 1005. The menu tabs 1005 include the ‘Active’tab 1010, the ‘Filed’tab 1012 and the ‘MTD connection errors’tab 1014.

In some embodiments, the set of tabs 1005 displayed in the GUI 1000 are defined by the user-defined configuration file (e.g. user-defined configuration file 270).

For example, the user-defined configuration file may comprise a menu or main menu property (“mainMenu”). The main menu property comprises one or more menu item properties. In the depicted example, the menu property associated with the GUI 1000 comprises a set of menu items defining the menu tabs 1005.

In some embodiments, each menu item property of a main menu property comprises the following properties: a label identifier (“labelID”), which comprises a unique string used to resolve the locale to be displayed in the GUI 1000, and a workboard configuration (“workboardConfig”), which comprises a reference to the data presentation configuration key that will be used to determine how the data is presented in the GUI 1000.

In some embodiments, the label identifier comprises a data element identifier. In some embodiments, the data presentation configuration key comprises a data key of a user-defined configuration file.

In some embodiments, the user-defined configuration file defines that a menu item property (“menuItem”) of a main menu property is associated with a sub-menu property (“submenu”). The sub menu property defines one or more sub menu options that may be displayed in association with the menu tab associated with the menu item property of the main menu property. The sub menu options may be displayed in a side panel of the GUI 1000.

The menu tabs defined by the main menu property and displayed by the GUI 1000 may be user-selectable. In some embodiments, a user may click on, or otherwise select, a menu tab in the set of menu tabs 1005. In response to a user selecting a menu tab, the GUI 1000 is configured to display a sub menu associated with the selected menu tab. The sub menu is indicated by the sub menu property of the menu item property, as part of the main menu configuration. As illustrated in FIG. 10, in response to the user selecting the ‘Active’ tab 1010, the GUI 1000 displays a sub menu 1015 in a side panel.

The sub menu 1015 in the side panel may comprise a set of sub menu items. For example, the sub menu 1015 comprises the sub menu items: ‘All’; ‘Company accounts and tax’; ‘Personal tax’; and ‘VAT’.

In some embodiments, the user-defined configuration file defines that a sub menu item (e.g. sub menu item VAT 1020) comprises properties including: a label identifier (labelID), which comprises a unique string that may be used to resolve the locale to be displayed in the user interface, and a default indicator (isDefaultOnLoad), which indicates whether the sub menu is displayed by default when the user interface is loaded on the client device. The default indicator may be set to either true or false. In response to the default indicator being set to true, and in response to the user selecting the tab menu associated with the sub menu, the GUI 1000 will default the user selection to the sub menu.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method comprising:
determining a data source comprising a plurality of data elements, each data element being associated with a respective data element identifier;
determining a user-defined configuration file for configuring a user interface, the configuration file comprising one or more of the data element identifiers, and for each of the one or more data element identifiers, a respective field identifier corresponding to a field of the user interface;
using the one or more of the plurality of data element identifiers, determining the one or more of the plurality of data elements from the data source associated with the respective data element identifiers;
determining generic list items and associated generic data;
determining user interface configuration data, the user interface configuration data being based on the user-defined configuration file, the one or more of the plurality of data elements, the generic list items and the associated generic data; and
providing the user interface configuration data to a client device for generating the user interface comprising one or more user-defined list items.

2. The method of claim 1, wherein the user-defined list items comprise one or more fields of a user interface, each field being associated with a field identifier and comprising one or more of the plurality of data elements.

3. The method of claim 1, wherein each generic list item comprises one or more field identifiers associated with a field of a user interface; and
wherein each field identifier of the one or more field identifiers of the generic list items corresponds with each of the one or more field identifiers of the user-defined configuration file.

4. The method of claim 3, wherein determining the user-defined list items comprises mapping each of the data elements to a respective field of the user interface based on the one or more field identifiers of the generic list items and the corresponding field identifiers of the user-defined configuration file.

5. The method of claim 2, wherein the generic data is indicative of qualities of the fields of the user interface.

6. The method of claim 5, wherein the qualities of the fields of a user interface comprise: a field type; a field title; a field label; a field style; a field format; a field data type; a field data source; and one or more field logic.

7. The method of claim 1, wherein each of the one or more data element identifiers has an associated set of user-defined presentation information for presenting the data element on the user interface.

8. The method of claim 7, wherein the user-defined configuration file further comprises user-defined presentation information for presenting the user interface.

9. The method of claim 7, wherein the user-defined presentation information comprise one or more of:
a layout type; a list type; a set of fields to be displayed; a field type; a display element visibility; a field style; a derived calculation; composite fields built from templates; text font; text colour; duration calculation; one or more date range; and/or one or more currency amount range.

10. The method of claim 1, wherein the one or more data elements are indicative of an: entity name; client name; business information; entity status; additional information; error status details; workflow status; work status; tax type; duration of a period; date; possible action; filed date; payment date; and/or due date.

11. The method of claim 1, wherein the user interface configuration data comprises filter configuration instructions, and;
wherein the filter configuration instructions are configured to enable a user of the client device to configure the user-defined list items.

12. (canceled)

13. The method of claim 1, wherein determining the user interface configuration data further comprises:
determining a schema of a user-defined configuration file;
determining the one or more field identifiers;
determining one or more field attributes of the fields of the user interface, based on the schema and the one or more field identifiers.

14. The method of claim 13, wherein the schema is indicative of logical constraints of the user-defined configuration file.

15. The method of claim 1, wherein
determining the user interface comprises:
determining a supplementary data source; and
determining from the supplementary data source, based on previously determined data source and/or the plurality of data elements, one or more supplementary data elements.

16. The method of claim 15, wherein the supplementary data elements of the supplementary data source are indicative of shared information that is available to all users.

17. The method of claim 15, wherein the supplementary data elements comprise data indicative of one or more of: an entity name; an entity location; associated entities; a responsible entity; and/or one or more logic functions.

18. The method of claim 1 wherein the user-defined configuration file further comprises function instructions, wherein the function instructions are indicative of operations that can be performed on one or more of the plurality of data elements.

19. The method of claim 1, wherein the user interface configuration data is: an API payload, or a file.

20. A non-transitory machine-readable medium storing instructions which, when executed by one or more processors, cause a computing device to perform a method comprising:
determining a data source comprising a plurality of data elements, each data element being associated with a respective data element identifier;
determining a user-defined configuration file for configuring a user interface, the configuration file comprising one or more of the data element identifiers, and for each of the one or more data element identifiers, a respective field identifier corresponding to a field of the user interface;
using the one or more of the plurality of data element identifiers, determining the one or more of the plurality of data elements from the data source associated with the respective data element identifiers;
determining generic list items and associated generic data;
determining user interface configuration data, the user interface configuration data being based on the user-defined configuration file, the one or more of the plurality of data elements, the generic list items and the associated generic data; and
providing the user interface configuration data to a client device for generating the user interface comprising one or more user-defined list items.

21. A system comprising:
one or more processors; and
memory comprising computer executable instructions, which when executed by the one or more processors, cause the system to perform a method comprising:
determining a data source comprising a plurality of data elements, each data element being associated with a respective data element identifier;
determining a user-defined configuration file for configuring a user interface, the configuration file comprising one or more of the data element identifiers, and for each of the one or more data element identifiers, a respective field identifier corresponding to a field of the user interface;
using the one or more of the plurality of data element identifiers, determining the one or more of the plurality of data elements from the data source associated with the respective data element identifiers;
determining generic list items and associated generic data;
determining user interface configuration data, the user interface configuration data being based on the user-defined configuration file, the one or more of the plurality of data elements, the generic list items and the associated generic data; and
providing the user interface configuration data to a client device for generating the user interface comprising one or more user-defined list items.
